(19) United States
(12) Patent Application Publication
(10) Pub. No.: US 2024/0023602 A1
(43) Pub. Date: Jan. 25, 2024

(54) CASE FOR AN AEROSOL DELIVERY DEVICE

(71) Applicant: Nicoventures Trading Limited, LONDON (GB)

(72) Inventors: Sam LAI, London (GB); Tomi VINTOLA, London (GB)

(21) Appl. No.: 18/257,356

(22) PCT Filed: Dec. 13, 2021
(86) PCT No.: PCT/GB2021/053258

§ 371 Date: Jun. 14, 2023

(30) Foreign Application Priority Data
Dec. 14, 2020 (GB) 2019673.9

(51) Int. Cl. A24F 15/01; A24F 40/51; A24F 40/95; H01M 10/46; H01M 10/48

(52) U.S. Cl. CPC A24F 15/01; A24F 40/51; A24F 40/95; H01M 10/46; H01M 10/488; H01M 2220/30

(57) ABSTRACT

A case for an aerosol delivery device, and a method for using the case, is described and can include a lid having an open position and a closed position; a magnet and hall sensor pair configured to provide a signal indicative of whether the lid is in the open position or the closed position; and a controller configured to receive a signal from the hall sensor indicative of whether the lid is open or closed.

### PRIORITY CLAIM

The present application is a National Phase Entry of PCT Application No. PCT/GB2021/053258, filed Dec. 13, 2021, which claims priority from GB Application No. 2019673.9, filed Dec. 14, 2020, each of which are hereby fully incorporated by reference.

### TECHNICAL FIELD

The present specification relates to a case (e.g. a carry case), in particular a case for an aerosol delivery device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol delivery device may be provided with a case, such as a carry case, for retaining the device when not in use. There remains a need for further developments in this field.

### SUMMARY

In a first aspect, this specification describes a case for an aerosol delivery device (which aerosol delivery device may, for example, comprise a tobacco heating system), the case comprising: a lid having an open position and a closed position; a magnet and hall sensor pair configured to provide a signal indicative of whether the lid is in the open position or the closed position; and a controller configured to receive a signal from the hall sensor indicative of whether the lid is open or closed. The aerosol delivery device may be a non-combustible aerosol provision device.

The magnet may be provided within the lid of the case. The hall sensor may be provided within a main body of the case.

The case may further comprise a battery status indicator, wherein the controller is configured to activate the battery status indicator upon detection of the lid changing from a closed position to an open position. The battery status indicator may, for example, comprise one or more light emitting diodes. The battery status indicator may, for example, be configured to indicate a status of a battery of an aerosol delivery device mounted within the case.

The case may further comprise the aerosol delivery device. The aerosol delivery device may be configured to receive a removable article comprising an aerosolizable material (which aerosolizable material may be present on a substrate).

The aerosol delivery device may comprise a tobacco heating system.

In a second aspect, this specification described a method comprising receiving a signal from a hall sensor indicative of whether a lid of a case for an aerosol delivery device is in an open is position or a closed position, wherein the signal is dependent on a position of a magnet relative to the hall sensor.

The magnet may be provided within the lid of the case. The hall sensor may be provided within a main body of the case.

The method may further comprise activating a battery status indicator of the case when the lid changes from a closed position to an open position. The battery status indicator may comprise one or more light emitting diodes. The battery status indicator may be configured to indicate a status of a battery of an aerosol delivery device mounted within the case.

The method may further comprise receiving the aerosol delivery device within the case.

In a third aspect, this specification describes a kit of parts comprising a case as described above with reference to the first aspect, an aerosol delivery device and an article for use in the aerosol delivery device. The aerosol delivery device may be a non-combustible aerosol provision device. The article may be a removable article comprising an aerosol generating material.

### BRIEF DESCRIPTION OF THE DRAWINGS

Example embodiments will now be described, by way of example only, with reference to the following schematic drawings, in which:

FIG. 1 shows a case for an aerosol delivery device in accordance with an example embodiment.

FIG. 2 is a block diagram of a non-combustible aerosol delivery device in accordance with an example embodiment.

FIG. 3 is a flow chart showing an algorithm in accordance with an example embodiment.

FIG. 4 is a block diagram of a system in accordance with an example embodiment.

FIG. 5 is a flow chart showing an algorithm in accordance with an example embodiment.

FIGS. 6 to 8 are block diagrams of displays in accordance with example embodiments.

FIG. 9 is a flow chart showing an algorithm in accordance with an example embodiment.

### DETAILED DESCRIPTION

As used herein, the term “aerosol delivery device” is intended to encompass systems that deliver a substance to a user, and includes:
non-combustible aerosol provision systems that release compounds from an aerosolizable material without combusting the aerosolizable material, such as electronic cigarettes, tobacco heating products, and hybrid systems to generate aerosol using a combination of aerosolizable materials; and
articles comprising aerosolizable material and configured to be used in one of these non-combustible aerosol provision systems.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol,propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable e material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

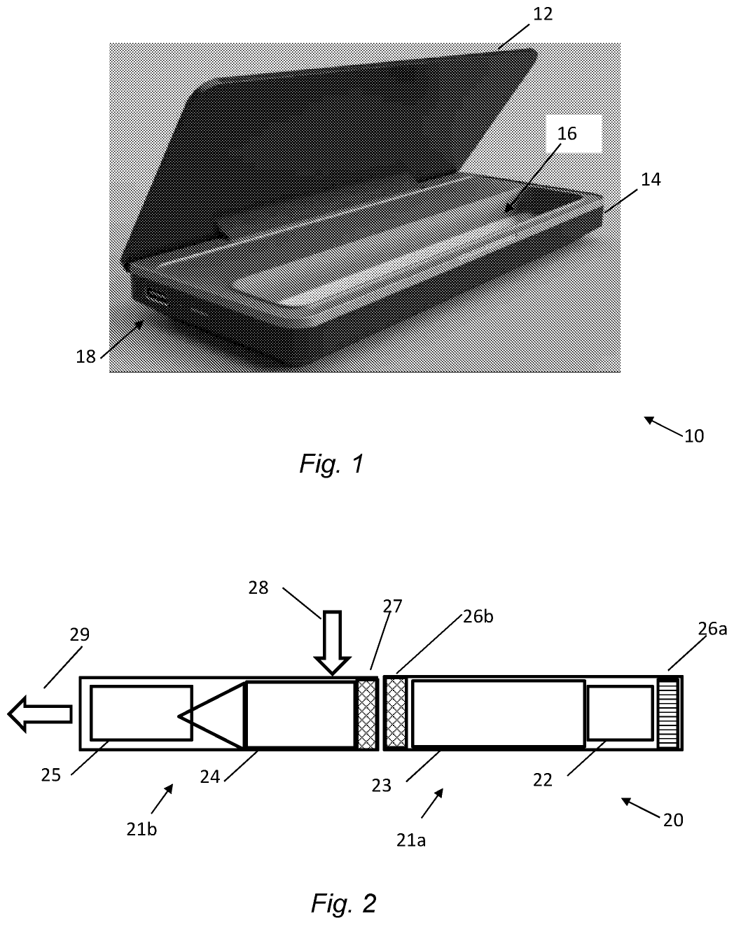

FIG. 1 shows a case for an aerosol delivery device, indicated generally by the reference numeral in accordance with an example embodiment. The case 10 comprises a lid 12 and a main body 14. The main body 14 includes a storage area 16 for storing an aerosol delivery device (not shown in FIG. 1). The aerosol delivery device may be a non-combustible aerosol generating device, although this is not essential to all example embodiments.

The case 10 includes a port 18 that may be used for charging a battery of an aerosol delivery device stored in the storage area 16.

FIG. 2 is a block diagram of a non-combustible aerosol delivery device, indicated generally by the reference numeral 20, in accordance with an example embodiment. The aerosol delivery device 20 may be stored within the area 16 of the case 10 described above. The device 20 is a modular device, comprising a first part 21a and a second part 21b. In some embodiments, the first part 21a and the second part 21b may be stored separately in the case 10 (e.g. detached from one another). The aerosol delivery device 20 may comprise a tobacco heating system.

The first part 21a of the device 20 includes a control circuit 22 and a battery 23. The second part 21b of the device 20 includes a heater 24 and a liquid reservoir 25 (that may collectively form an aerosol generator).

The first part 21a includes a first connector 26a (such as a USB connector). The first connector 26a may enable connection to be made to a power source (e.g. a battery of the case 10 or an external power supply via the port 18 of the case 10) for charging the battery 23, for example under the control of the control circuit 22.

The first part 21a also includes a second connector 26b that can be removably connected to a first connector 27 of the second part 21b.

In the use of the device 20, air is drawn into an air inlet of the heater 24, as indicated by the arrow 28. The heater is used to heat the air (e.g. under the control of the circuit 23). The heated air is directed to the liquid reservoir 25, where an aerosol is generated. The aerosol exits the device at an air outlet, as indicated by the arrow 29 (for example into the mouth of a user of the device 20).

The liquid reservoir 25 may be provided by a removable article comprising an aerosol generating material. The aerosol generating material may comprise an aerosol generating substrate and an aerosol forming material.

It should be noted that the device 20 is described by way of example only. Many alternative devices could be stored within the case 10 in accordance with example embodiments.

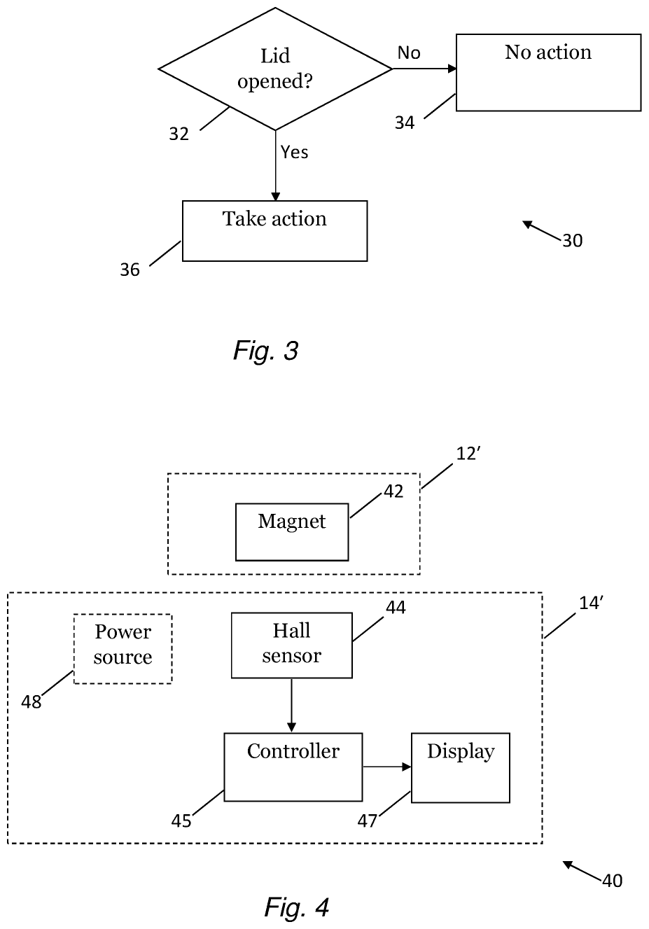

FIG. 3 is a flow chart showing an algorithm, indicated generally by the reference numeral 30, in accordance with an example embodiment.

The algorithm 30 starts at operation 32, where a determination is made regarding whether the lid 12 of the case 10 has been opened. If not, the algorithm 30 moves to operation 34 where no action is taken. The algorithm 30 may then terminate, or may return to the operation 32.

If it is determined in the operation 32 that the lid has been opened, then the algorithm 30 moves to operation 36 where action is taken in response to the opening of the lid. Example actions are discussed further below.

Of course, the algorithm 30 shown in FIG. 3 is highly schematic and may be implemented in many different ways. For example, the algorithm 30 may be implemented as an interrupt routine, wherein the detection of the lid changing from a closed state to the opened state triggers the operation 36 (where action is taken).

FIG. 4 is a block diagram of a system, indicated generally by the reference numeral 40, in accordance with an example embodiment.

The system 40 comprises a magnet 42, a hall sensor 44, a controller 45, a display 47 and a power source 48. Although not essential to all example embodiments, the magnet 42 may be provided within the lid 12 of the case 10 (as indicated by the dotted box 12′ in FIG. 4) and the hall sensor 44, controller 45, display 47 and power source 48 may be provided within the main body 14 of the case 10 (as indicated by the dotted box 14′ in FIG. 4). Of course, the alternative configuration (with the magnet in the main body 14 and the hall sensor in the lid) is possible.

The power source 48 (such as a battery) may provide power to the various elements within the main body of the case 10 (such as the hall sensor 44, the controller 45 and the display 47). In some example embodiments, the battery 23 of an aerosol delivery device 20 mounted within the storage area 16 of the case 10 may be used to power the elements within the main body of the case in addition to, or instead of, the power source 48. Indeed in some example embodiments, the power source 48 may be omitted.

The magnet 42 may be a permanent magnet. As such, the magnet may not require a power source. This may be advantageous if the magnet 42 is provided within the lid of the case 10, since it may avoid the need to provide power to the lid.

As discussed in detail below, the controller 45 is configured to control the display 47.

The magnet 42 and the hall sensor 44 may form a magnet and hall sensor pair configured to provide a signal indicative of whether the lid is in the open position or the closed position, thereby implementing the operation 32 of the algorithm 30 described above.

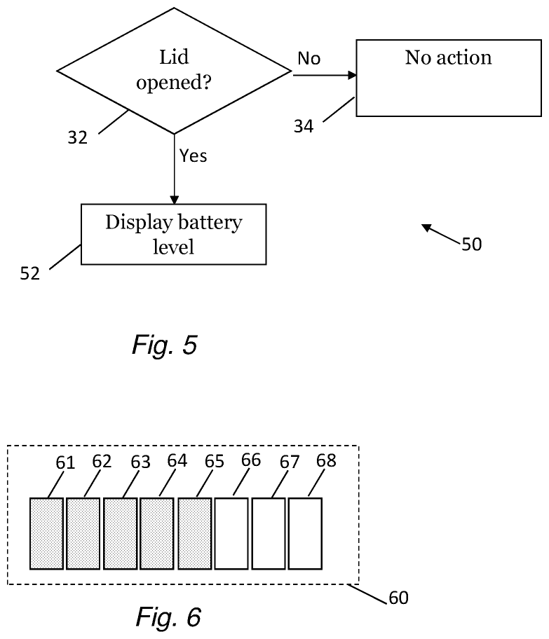

FIG. 5 is a flow chart showing an algorithm in accordance with an example embodiment.

The algorithm 50 starts at operation 32, where, as discussed above, a determination is made regarding whether the lid 12 of the case 10 has been opened. That determination may be made by the controller 45, based on the output of the magnet-hall sensor pair 42 and 44. If not, the algorithm 50 moves to operation 34 where no action is taken. The algorithm 30 may then terminate, or may return to the operation 32.

If it is determined in the operation 32 that the lid has been opened, then the algorithm 50 moves to operation 52 where a battery level is displayed, thereby implementing operation 36 of the algorithm 30 described above. The battery level may be the state of charge of the power source 48 and/or the battery 23 of the device 20 described above.

FIG. 6 is a block diagram of a battery status indicator 60. The battery status indicator 60 is an example of the display 47 and may be used to display a battery level, thereby implementing the operation 52 described above.

The battery status indicator 60 comprises a plurality of status indicator elements 61 to 68. The status indicator elements 61 to 68 may, for example, be light emitting diodes (LEDs).

In response to the lid 12 of the case 10 being opened, the indicator elements 61 to 68 may be selectively illuminated to provide an indication of a battery status (e.g. the charge level of the relevant battery). In this way, battery charge status information can be provided to the user when the case is opened, but does not need to be provided at other times (thereby reducing battery usage). In the example indicator 60, the indicator elements 61 to 65 are illuminated and the indicator elements 66 to 68 are not illuminated.

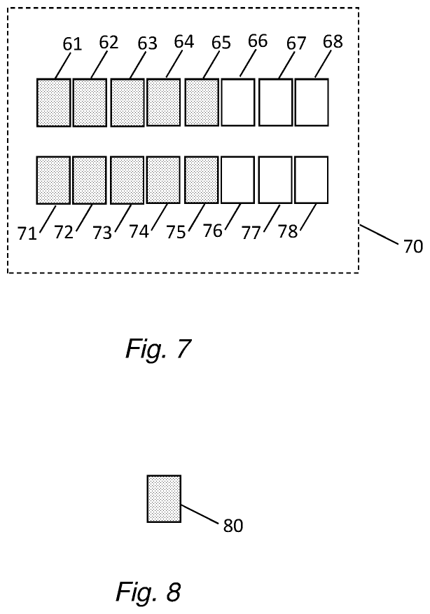

FIG. 7 is a block diagram of a battery status indicator 70. The battery status indicator 70 is an example of the display 47 and may be used to display a battery level of both the power source 48 and the battery 23 of the device 20 (if present), thereby implementing the operation 52 described above. The battery status indicator 70 comprises the first plurality of status indicator elements 61 to 68 and a second plurality of indicator elements 71 to 78. The first and second status indicator elements may, for example, be light emitting diodes (LEDs).

In response to the lid 12 of the case 10 being opened, the first indicator elements 61 to 68 may be selectively illuminated to provide an indication of a charge level of the power source 48 and the second indicator elements 71 to 78 may be selectively illuminated to provide an indication of a charge level of the battery 23.

The battery status indicators 60 and 70 described above are two example embodiments; many variants are possible. By way of example, FIG. 8 is a block diagram of a battery status indictor that may be used as the display 47 and may be used to display a battery level. The battery status indicator 80 comprises a single LED that can be illuminated in different colors in order to indicate the battery status. For example, the LED of the indictor 80 may be illuminated green if the battery level is good (e.g. above a first threshold), the indicator 80 may be illuminated red if the batter level is poor (e.g. below a second threshold) and the indicator 80 may be illuminated amber if the batter level is neither good nor poor (e.g. between the first and second threshold). Of course, two LEDs could be provided, with one indicating the status of the power source 48 and the other indicating the status of the battery 23.

In the example embodiments described above, action is taken in response to detecting the opening the lid of the case 10. This is not essential to all example embodiments.

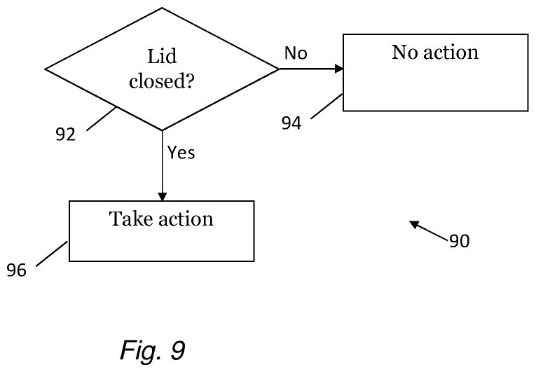

By way of example, FIG. 9 is a flow chart showing an algorithm, indicated generally by the reference numeral 90, in accordance with an example embodiment. The algorithm 90 has many similarities with the algorithm 30 described above.

The algorithm 90 starts at operation 92, where a determination is made regarding whether the lid 12 of the case 10 has been closed. If not, the algorithm 90 moves to operation 94 where no action is taken. The algorithm 90 may then terminate, or may return to the operation 92.

If it is determined in the operation 92 that the lid has been closed, then the algorithm 90 moves to operation 96 where action is taken in response to the opening of the lid (such as providing a battery level indication, as discussed above).

In common with the algorithm 30 described above, then algorithm 90 shown in FIG. 9 is highly schematic and may be implemented in many different ways.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

4872-7505-1370, v. 1

1. A case for an aerosol delivery device, the case comprising:
a lid having an open position and a closed position;
a magnet and a hall sensor pair configured to provide a signal indicative of whether the lid is in the open position or the closed position; and
a controller configured to receive a signal from the hall sensor indicative of whether the lid is in the open position or the closed position.

2. The case as claimed in claim 1, wherein the magnet is provided within the lid of the case.

3. The case as claimed in claim 1, wherein the hall sensor is provided within a main body of the case.

4. The case as claimed in claim 1, further comprising a battery status indicator, wherein the controller is configured to activate the battery status indicator upon detection of the lid changing from the closed position to the open position.

5. The case as claimed in claim 4, wherein the battery status indicator comprises one or more light emitting diodes.

6. The case as claimed in claim 4, wherein the battery status indicator is configured to indicate a status of a battery of an aerosol delivery device mounted within the case.

7. The case as claimed in claim 1, wherein the aerosol delivery device is a non-combustible aerosol provision device.

8. The case as claimed in claim 1, further comprising the aerosol delivery device.

9. The case as claimed in claim 8, wherein the aerosol delivery device is configured to receive a removable article comprising an aerosolizable material.

10. The case as claimed in claim 9, wherein the aerosolizable material is present on a substrate.

11. The case as claimed in claim 1, wherein the aerosol delivery device comprises a tobacco heating system.

12. A method comprising:
receiving a signal from a hall sensor indicative of whether a lid of a case for an aerosol delivery device is in an open position or a closed position, wherein the signal is dependent on a position of a magnet relative to the hall sensor.

13. The method as claimed in claim 12, wherein the magnet is provided within the lid of the case.

14. The method as claimed in claim 12, wherein the hall sensor is provided within a main body of the case.

15. The method as claimed in claim 12, further comprising activating a battery status indicator of the case when the lid changes from the closed position to the open position.

16. The method as claimed in claim 15, wherein the battery status indicator comprises one or more light emitting diodes.

17. The method as claimed in claim 15, wherein the battery status indicator is configured to indicate a status of a battery of an aerosol delivery device mounted within the case.

18. The method as claimed in claim 12, further comprising receiving the aerosol delivery device within the case.

19. A kit of parts comprising a case as claimed in claim 1, an aerosol delivery device and an article for use in the aerosol delivery device.

20. The kit of parts as claimed in claim 19, wherein the aerosol delivery device is a non-combustible aerosol provision device.

21. The kit of parts as claimed in claim 19, wherein the article is a removable article comprising an aerosol generating material.
